(19) United States
(12) Patent Application Publication
(10) Pub. No.: US 2007/0237364 A1
(43) Pub. Date: Oct. 11, 2007

(54) Method and apparatus for context-aided human identification

(75) Inventors: Yang Song, San Jose, CA (US); Thomas Leung, San Jose, CA (US)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/394,242

(22) Filed: Mar. 31, 2006

(51) Int. Cl. G06K 9/00; G06K 9/46

(52) U.S. Cl. 382/115; 382/195

(57) ABSTRACT

A method and an apparatus process digital images. The method according to one embodiment accesses digital data representing a plurality of digital images including a plurality of persons; performs face recognition to generate face recognition scores relating to similarity between faces of the plurality of persons; performs clothes recognition to generate clothes recognition scores relating to similarity between clothes of the plurality of persons; obtains inter-relational person scores relating to similarity between persons of the plurality of persons using the face recognition scores and the clothes recognition scores; and clusters the plurality of persons from the plurality of digital images using the inter-relational person scores to obtain clusters relating to identities of the persons from the plurality of persons.

### CROSS REFERENCE TO RELATED APPLICATIONS

This non-provisional application is related to co-pending non-provisional applications titled “Method and Apparatus for Performing Constrained Spectral Clustering of Digital Image Data” and “Method and Apparatus for Adaptive Context-Aided Human Classification” filed concurrently herewith, the entire contents of which are hereby incorporated by reference.

### BACKGROUND OF THE INVENTION

1. Field of the Invention

The present invention relates to an identification and classification technique, and more particularly to a method and apparatus for identifying and classifying images of objects, such as people, in digital image data.

2. Description of the Related Art

Identification and classification of objects in images is an important application useful in many fields. For example, identification and classification of people in images is important and useful for automatic organization and retrieval of images in photo albums, for security applications, etc. Face recognition has been used to identify people in photographs and digital image data.

Reliable face recognition, however, is difficult to achieve because of variations in image conditions and human imaging. Such variations include: 1) lighting variations, such as indoors vs. outdoor illuminations or back-lit vs. front lit images of people; 2) pose changes, such as frontal view vs. side view of people; 3) poor image quality, such as face out of focus or motion blur in images; 4) different facial expressions, such as open eyes vs. closed eyes, open mouth vs. closed mouth, etc; 5) aging of people; etc.

A few publications have studied human recognition techniques in images. One such technique is described in “Automated Annotation of Human Faces in Family Albums”, by L. Zhang, L. Chen, M. Li, and H. Zhang, in Proc. ACM Multimedia, MM'03, Berkeley, Calif., USA, Nov. 2-8, 2003, which discloses human identification methods. In this publication, facial features and contextual features are used to characterize people in images. In this human identification method, however, the facial features and the contextual features of people are assumed to be independent. This is not an accurate assumption and hampers the effectiveness of using facial features and contextual features to characterize people. Also, lighting changes and clutters (from background or from other people) pose challenges for using contextual features effectively, because in this publication the contextual features are from fixed color spaces, so they suffer when lighting conditions change. Moreover, in this publication automatic clustering is not done, only an image search being available.

Disclosed embodiments of this application address issues associated with human recognition and identification, by using a context-aided human identification method and apparatus that can identify people in images using context information. The method and apparatus use a novel clothes recognition algorithm, perform a principled integration of face and clothes recognition data, and cluster images to obtain identification results for human subjects present in images. The clothes recognition algorithm is robust to lighting changes and eliminates background clutter.

### SUMMARY OF THE INVENTION

The present invention is directed to a method and an apparatus that process digital images. According to a first aspect of the present invention, a digital image processing method comprises: accessing digital data representing a plurality of digital images including a plurality of persons; performing face recognition to generate face recognition scores relating to similarity between faces of the plurality of persons; performing clothes recognition to generate clothes recognition scores relating to similarity between clothes of the plurality of persons; obtaining inter-relational person scores relating to similarity between persons of the plurality of persons using the face recognition scores and the clothes recognition scores; and clustering the plurality of persons from the plurality of digital images using the inter-relational person scores to obtain clusters relating to identities of the persons from the plurality of persons.

According to a second aspect of the present invention, a digital image processing apparatus comprises: an image data unit for providing digital data representing a plurality of digital images including a plurality of persons; a face recognition unit for generating face recognition scores relating to similarity between faces of the plurality of persons; a clothes recognition unit for generating clothes recognition scores relating to similarity between clothes of the plurality of persons; a combination unit for obtaining inter-relational person scores relating to similarity between persons of the plurality of persons using the face recognition scores and the clothes recognition scores; and a classification unit for clustering the plurality of persons from the plurality of digital images using the inter-relational person scores to obtain clusters relating to identities of the persons from the plurality of persons.

### BRIEF DESCRIPTION OF THE DRAWINGS

Further aspects and advantages of the present invention will become apparent upon reading the following detailed description in conjunction with the accompanying drawings, in which:

FIG. 1 is a general block diagram of a system including an image processing unit for performing context-aided human identification of people in digital image data according to an embodiment of the present invention;

FIG. 2 is a block diagram illustrating in more detail aspects of an image processing unit for performing context-aided human identification of people in digital image data according to an embodiment of the present invention;

FIG. 3 is a flow diagram illustrating operations performed by an image processing unit for context-aided human identification of people in digital image data according to an embodiment of the present invention illustrated in FIG. 2;

FIG. 4 is a flow diagram illustrating operations performed by a clothes recognition module to perform clothes recognition in images according to an embodiment of the present invention;

FIG. 5 is a flow diagram illustrating a technique for clothes detection and segmentation in digital image data performed by a clothes recognition module according to an embodiment of the present invention illustrated in FIG. 4;

FIG. 6A illustrates an exemplary result of initial detection of clothes location according to an embodiment of the present invention illustrated in FIG. 5;

FIG. 6B illustrates an exemplary result of clothes segmentation to refine clothes location according to an embodiment of the present invention illustrated in FIG. 5;

FIG. 7 is a flow diagram illustrating a technique for clothes representation by feature extraction according to an embodiment of the present invention illustrated in FIG. 4;

FIG. 8A illustrates exemplary code-words obtained from clothes feature extraction for clothes in a set of images according to an embodiment of the present invention illustrated in FIG. 7;

FIG. 8B illustrates exemplary code-words frequency feature vectors obtained for clothes representation of clothes in a set of images according to an embodiment of the present invention illustrated in FIG. 7;

FIG. 9 is a flow diagram illustrating a technique for detection and removal of skin clutters from clothes in digital image data according to an embodiment of the present invention illustrated in FIG. 5;

FIG. 10 is a flow diagram illustrating a technique for computing the similarity between pieces of clothes in digital image data according to an embodiment of the present invention illustrated in FIG. 4;

FIG. 11A is a diagram illustrating techniques for combining face and clothes recognition results to obtain combined similarity measures for person images according to an embodiment of the present invention;

FIG. 11B is a flow diagram illustrating a technique for determining similarity measures for person images based on availability of face and clothes similarity scores according to an embodiment of the present invention; and

FIG. 12 is a flow diagram illustrating techniques for performing classification of person images based on person identities according to an embodiment of the present invention.

### DETAILED DESCRIPTION

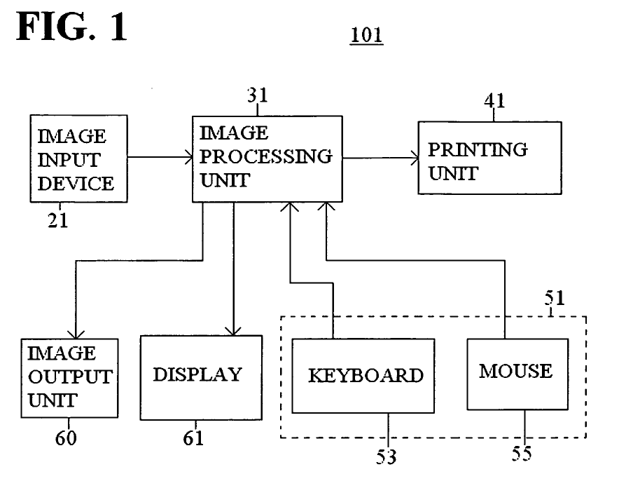

Aspects of the invention are more specifically set forth in the accompanying description with reference to the appended figures. FIG. 1 is a general block diagram of a system including an image processing unit for performing context-aided human identification of people in digital image data according to an embodiment of the present invention. The system 101 illustrated in FIG. 1 includes the following components: an image input device 21; an image processing unit 31; a display 61; a user input unit 51; an image output unit 60; and a printing unit 41. Operation of the system 101 in FIG. 1 will become apparent from the following discussion.

The image input device 21 provides image data to image processing unit 31. Image data can be digital images. Examples of digital images that can be input by image input device 21 are photographs of people in everyday activities, photographs of people taken for security or identification purposes, etc. Image input device 21 may be one or more of any number of devices providing digital image data. Image input device 21 could provide digital image data derived from a database of images, a digital system, etc. Image input device 21 may be a scanner for scanning black and white or color images recorded on film; a digital camera; a recording medium such as a CD-R, a floppy disk, a USB drive, etc.; a database system which stores images; a network connection; an image processing system that outputs digital data, such as a computer application that processes images; etc.

The image processing unit 31 receives image data from the image input device 21, and performs context-aided human identification of people in digital image data, in a manner discussed in detail below. A user may view outputs of image processing unit 31, including intermediate results of context-aided human identification of people in digital image data, via display 61, and may input commands to the image processing unit 31 via the user input unit 51. In the embodiment illustrated in FIG. 1, the user input unit 51 includes a keyboard 53 and a mouse 55, but other conventional input devices could also be used.

In addition to performing context-aided human identification of people in digital image data in accordance with embodiments of the present invention, the image processing unit 31 may perform additional image processing functions, such as known color/density correction functions, as well as image cropping, compression, etc. in accordance with commands received from the user input unit 51. The printing unit 41 receives the output of the image processing unit 31 and generates a hard copy of the processed image data. The printing unit 41 may expose a light-sensitive material according to image data output by the image processing unit 31 to record an image on the light-sensitive material. The printing unit 41 may take on other forms, such as a color laser printer. In addition to or as an alternative to generating a hard copy of the output of the image processing unit 31, the processed image data may be returned to the user as a file, e.g., via a portable recording medium or via a network (not shown). The display 61 receives the output of the image processing unit 31 and displays image data together with context-aided human identification results for people in the image data. The output of the image processing unit 31 may also be sent to image output unit 60. Image output unit 60 can be a database that stores context-aided human identification results received from image processing unit 31.

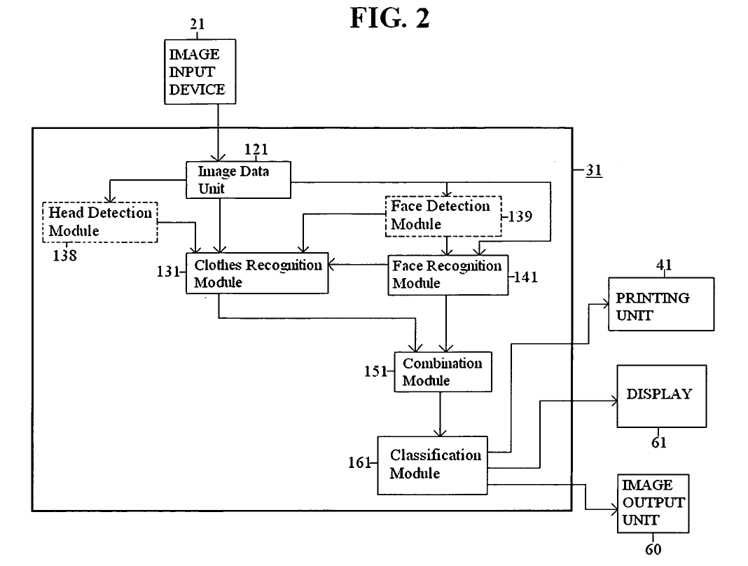

FIG. 2 is a block diagram illustrating in more detail aspects of an image processing unit 31 for performing context-aided human identification of people in digital image data according to an embodiment of the present invention. As shown in FIG. 2, image processing unit 31 according to this embodiment includes: an image data unit 121; a clothes recognition module 131; a face recognition module 141; a combination module 151; a classification module 161; an optional face detection module 139; and an optional head detection module 138. Although the various components of FIG. 2 are illustrated as discrete elements, such an illustration is for ease of explanation and it should be recognized that certain operations of the various components may be performed by the same physical device, e.g., by one or more microprocessors.

Generally, the arrangement of elements for the image processing unit 31 illustrated in FIG. 2 inputs a set of images from image input device 21, performs recognition of clothes and faces in the images from the set of images, combines results of clothes and face recognition for the set of images, and clusters images according to identities of people shown in the images. Classification module 161 outputs identification results for people in the set of images together with grouping results of the images based on the identities of the people shown in the images. Such identification and grouping results may be output to printing unit 41, display 61 and/or image output unit 60. Image data unit 121 may also perform preprocessing and preparation operations on images before sending them to clothes recognition module 131, face recognition module 141, optional face detection module 139, and optional head detection module 138. Preprocessing and preparation operations performed on images may include resizing, cropping, compression, color correction, etc., that change size, color, appearance of the images, etc.

Face detection determines locations and sizes of faces in a set of images. Face recognition determines the identities of detected faces with known locations and sizes. Hence, face recognition is typically performed after face detection. Face detection is performed by the optional face detection module 139, when the module is present. Face detection may also be performed by face recognition module 141, when the face recognition module 141 includes a sub-module for face detection. Hence, in this case, performing face recognition includes performing face detection. Clothes recognition module 131 may communicate with face recognition module 141 or with optional face detection module 139 to obtain results of face detection. Alternatively, clothes recognition module 131 may obtain results of head detection from optional head detection module 138.

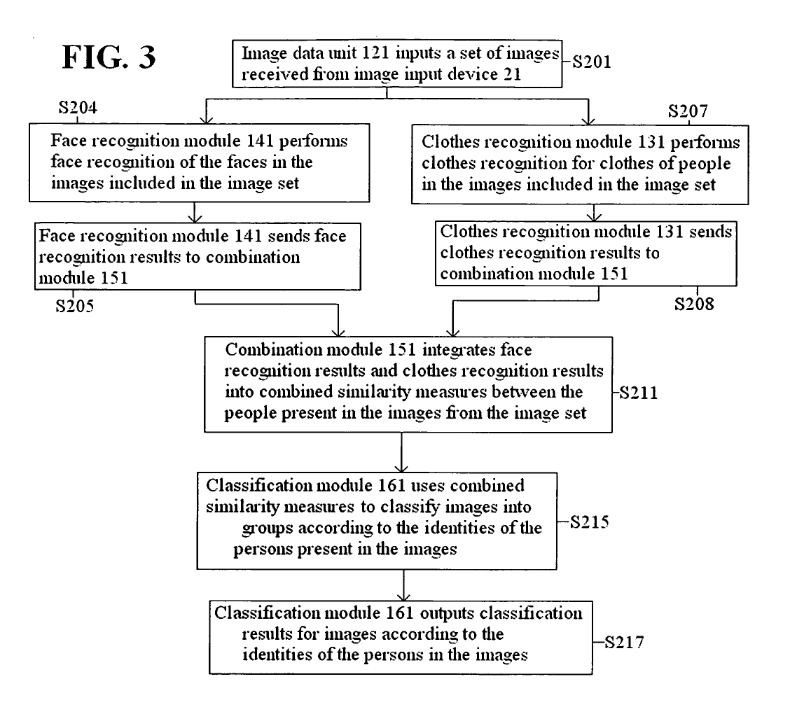

Clothes recognition module 131, face recognition module 141, combination module 151, classification module 161, face detection module 139, and head detection module 138 are software systems/applications in an exemplary implementation. Operation of the components included in the image processing unit 31 illustrated in FIG. 2 will be next described with reference to FIGS. 3-12.

Automatic organization of photographs is an important application with many potential uses such as photo album organization and security applications. Human identification techniques that can organize pictures according to one or more persons' identities by using face information, clothes information, picture record data, and other context cues, are implemented in the current application. Persons in the pictures are hence placed into groups based on the persons' identities, so that all the images of the same individual are in one group, while images from other individuals are in other groups.

A method and apparatus for context-aided human identification of people in digital image data can group images based on people's identities using face recognition as well as other cues in images. Information besides faces (also called ‘context’ information in the current application) can provide rich cues for recognizing people. Three types of context information are typically present in images. The first type of context information is appearance-based, such as the clothes a person is wearing; the second type of context information is logic-based, and can be expressed, for example, by the fact that different faces in one picture belong to different persons, or by the fact that some people are more likely to be pictured together (e.g. husband and wife); the third type of context information is meta-data of pictures such as the picture-taken-time. These three types of context information are often used by human observers consciously or unconsciously to differentiate between people in pictures. A context-aided human identification method that can utilize context information effectively can improve human recognition accuracy.

The method and apparatus presented in this application automatically organize pictures, according to persons' identities, by using faces and as much context information as possible. The method described in the current application uses context information and improves upon results from a face recognition engine.

The phrases “person image”, “people images”, or “person images” are used interchangeably in the current application to refer to images of people in an image. Hence, an image that shows three people contains three person images, while an image that shows one person contains one person image.

FIG. 3 is a flow diagram illustrating operations performed by an image processing unit 31 for context-aided human identification of people in digital image data according to an embodiment of the present invention illustrated in FIG. 2. Image data unit 121 inputs a set of images received from image input device 21 (S201). The images may be pictures of people taken under different poses, at different times of day, in different days, and in different environments.

Face recognition module 141 receives the set of images and performs face recognition of the faces in the images included in the image set (S204). Face recognition is used to obtain face information that is associated with the identities of faces. Face recognition module 141 may perform face recognition and obtain face recognition results using methods described in the publication “Texton Correlation for Recognition”, by T. Leung, in Proc. European Conference Computer Vision, ECCV 2004, pp. 203-214, which is herein incorporated by reference. In “Texton Correlation for Recognition” faces are represented using local characteristic features called textons, so that face appearance variations due to changing conditions are encoded by the correlations between the textons. The correlations between the textons contain face information associated with the identities of faces. Two methods can be used to model texton correlations. One method is a conditional texton distribution model and assumes locational independence. The second method uses Fisher linear discriminant analysis to obtain second order variations across locations. The texton models can be used for face recognition in images across wide ranges of illuminations, poses, and time. Other face recognition techniques may also be used by face recognition module 141.

Face recognition module 141 outputs face recognition results to combination module 151 (S205). Face recognition module 141 may output face recognition results in the form of scores relating to face similarities. Such scores may measure similarities between faces in face pairs and indicate correlations between two faces from the same or from different images. If two faces from different images belong to the same person, the faces would exhibit a high correlation. On the other hand, if two faces from different images belong to different people, the faces would exhibit a low correlation.

Clothes recognition module 131 receives the set of images from image data unit 121 as well, performs clothes recognition, and obtains clothes recognition results (S207). Clothes recognition results may be similarity scores for clothes of people in the images included in the image set. Clothes, as referred to in the current invention, include actual clothes as well as other external objects associated with people in images. In the current application, the term “clothes” refers to actual clothes, as well as hats, shoes, watches, eyeglasses, etc., as all these objects can be useful in discriminating between different people. Clothes recognition module 131 outputs clothes recognition results to combination module 151 (S208).

Combination module 151 receives face recognition results from face recognition module 141 and clothes recognition results from clothes recognition module 131. Combination module 151 then integrates face recognition results and clothes recognition results into combined similarity measures between the people present in the images (S211). Combined similarity measures integrating both face recognition results and clothes recognition results implement a more robust method for determining whether two people from different images are the same person or not. Linear logistic regression, Fisher linear discriminant analysis, or mixture of experts may be used to combine face and clothes recognition results and obtain combined similarity measures. A linear logistic regression method that combines face and clothes recognition results to obtain combined similarity measures may use techniques described in the cross-referenced related US application titled “Method and Apparatus for Adaptive Context-Aided Human Classification”, the entire contents of which are hereby incorporated by reference.

Classification module 161 receives combined similarity measures from combination module 151. Based on the combined similarity measures, classification module 161 groups images into clusters according to the identities of the persons present in the images (S215). Classification module 161 may perform clustering of images using methods described in the cross-referenced related US application titled “Method and Apparatus for Performing Constrained Spectral Clustering of Digital Image Data”, the entire contents of which are hereby incorporated by reference. Classification module 161 then outputs clustering results (S217). Such clustering results for images may be output to printing unit 41, display 61, and/or image output unit 60.

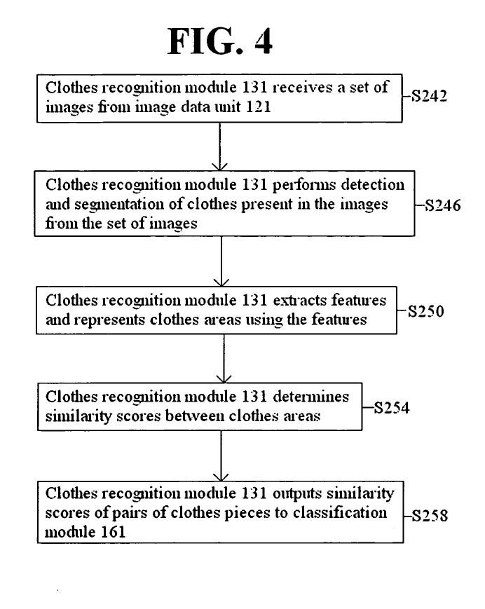

FIG. 4 is a flow diagram illustrating operations performed by a clothes recognition module 131 to perform clothes recognition in images according to an embodiment of the present invention. Clothes recognition is performed to identify clothes pieces in images, determine how similar clothes pieces are to each other, and hence indicate how likely it is that two clothes pieces from two person images actually belong to the same individual. There are three steps included in the clothes recognition method: clothes detection and segmentation, clothes representation by feature extraction, and similarity computation based on extracted features.

Clothes recognition module 131 receives a set of images from image data unit 121 (S242). Clothes recognition module 131 then performs detection and segmentation of clothes present in the images from the set of images (S246). Clothes detection and segmentation is performed to identify clothes areas in an image including people. An initial estimation of clothes location is obtained from face detection, by using results of face detection from face recognition module 141 or optional face detection module 139. Face recognition module 141 and optional face detection module 139 may perform face detection using one or more of the methods described in the following publications which are herein incorporated by reference: “Red Eye Detection with Machine Learning”, by S. loffe, in Proc. ICIP, 2003, “A Statistical Method for 3D Object Detection Applied to Faces and Cars”, by H. Schneiderman and T. Kanade, in Proc. CVPR, 2000, and “Rapid Object Detection Using a Boosted Cascade of Simple Features”, by P. Viola and M. Jones, in Proc. CVPR, 2001. An initial estimation of clothes location can also be obtained from results of head detection from optional head detection module 138.

Clothes recognition module 131 next extracts features and represents clothes areas using the features (S250). The numerical representations of clothes areas generated by clothes recognition module 131 permit manipulation of the clothes areas for further analysis of the clothes areas. Clothes recognition module 131 finally performs a similarity computation, to determine similarity scores between various clothes areas (S254). Clothes recognition module 131 then outputs similarity scores for pairs of clothes pieces to classification module 161 (S258).

Clothes recognition results in the form of similarity scores measure the degree of similarity between clothes of different people. For example, when a person appears in two images wearing the same clothes, a score associated with the clothes of that person in the two different images indicates that the clothes are similar.

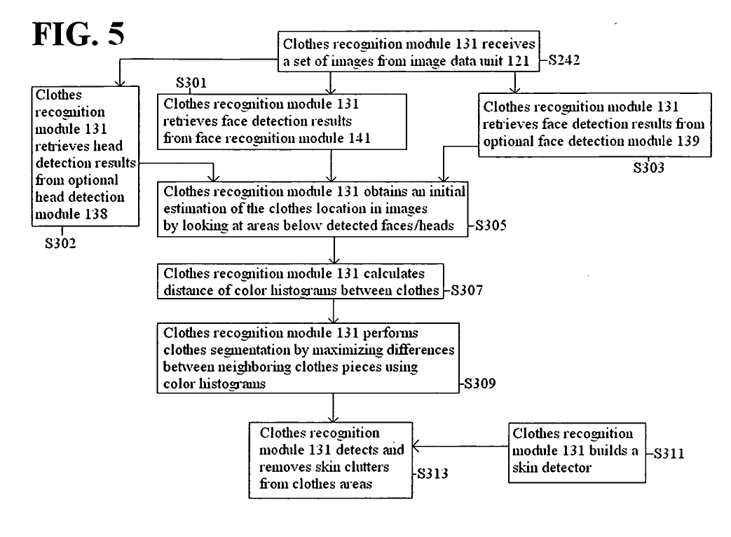

FIG. 5 is a flow diagram illustrating a technique for clothes detection and segmentation in digital image data performed by a clothes recognition module 131 according to an embodiment of the present invention illustrated in FIG. 4. FIG. 5 describes a technique for performing step S246 from FIG. 4. Clothes detection and segmentation is performed to identify the clothes areas in images including people. Precise contours of clothes are not necessary for clothes recognition. Rather, locating representative parts of the clothes is enough. Clutters are then removed from the identified representative parts of clothes. Clutters represent image areas that are not actually part of clothes areas, but are mixed or intermixed with clothes areas. Clutters include skin areas, such as the skin of the people wearing the clothes. Clutters also include occluding objects such as objects located in front of a person and occluding part of the person's clothes, etc. Clothes detection and segmentation includes an initial estimation of clothes location to detect clothes, segmentation of clothes areas in images to refine clothes location, and removal of clutters from the identified clothes areas.

An initial estimation of the clothes location can be obtained by first running face or head detection to detect locations of faces or heads in images, and then finding clothes areas in parts of the images below the detected heads or faces. Face detection may be performed by face recognition module 141 or by optional face detection module 139, and head detection may be performed by optional head detection module 138. Clothes recognition module 131 retrieves the face/head detection results from face recognition module 141 (S301), from optional face detection module 139 (S303), or from optional head detection module 138 (S302). Face detection may be performed using one or more of the methods described in the following publications which are herein incorporated by reference: “Red Eye Detection with Machine Learning”, by S. loffe, in Proc. ICIP, 2003, “A Statistical Method for 3D Object Detection Applied to Faces and Cars”, by H. Schneiderman and T. Kanade, in Proc. CVPR, 2000, and “Rapid Object Detection Using a Boosted Cascade of Simple Features”, by P. Viola and M. Jones, in Proc. CVPR, 2001. Head detection may be performed using methods similar to the methods described in the above publications. Other methods may also be used for head detection. Face detection can typically achieve better accuracy than face recognition. For example, profile faces can be detected by face detection algorithms, but they present a challenge for state-of-the-art face recognition algorithms. Results derived from face detection can be complimentary to face recognition results of face recognition module 141. From face detection or head detection, clothes recognition module 131 obtains an initial estimation of the clothes location by looking at areas below the detected faces or heads (S305). Face detection or head detection results are therefore used to obtain an initial estimation of clothes location.

Clothes location using face detection alone can, however, encounter challenges and produce unsatisfactory results due to occlusions of the clothes of a person. Such occlusions can be another person in the image that occludes the first person's clothes, the limbs and skin of the first person herself, or other objects present in the environment shown in the picture. To improve upon the initial estimation of clothes locations, clothes segmentation and clutter removal is performed after the initial estimation of clothes locations.

During the clothes segmentation step, clothes are segmented among different people by maximizing the difference of neighboring clothes pieces (S309). The difference between neighboring clothes pieces can be computed by the _{χ}² distance of color histograms in the CIELAB color space (S307). Starting with the initial estimation of clothes locations obtained from face detection results, and assuming that the ‘true’ clothes are not far away from the initial estimation of clothes locations, clothes recognition module 131 obtains improved candidate locations for clothes by shifting and resizing the initial location estimation, based on the distance of color histograms between clothes pieces (S309). The candidate image areas that can maximize the difference between neighboring clothes pieces are selected for improved locations of clothes.

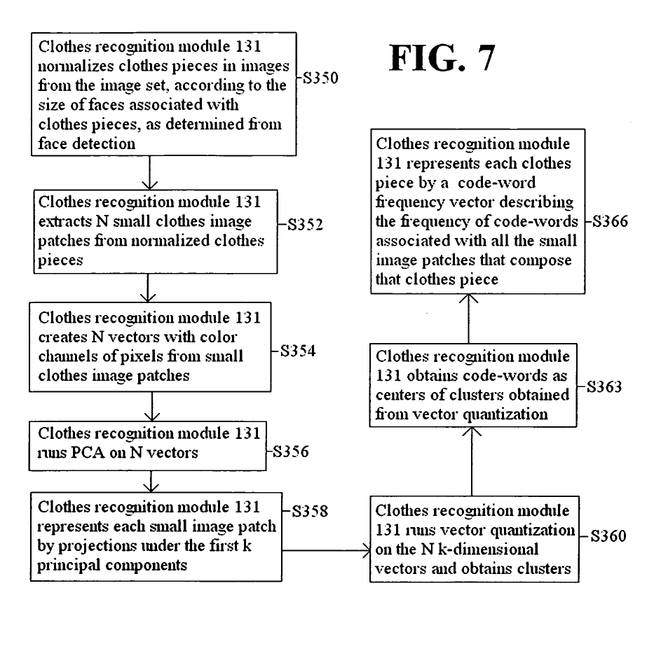

Clothes recognition module 131 performs clutter removal next. Clutter removal gets rid of clutters, which are areas detected as clothes from the segmentation step S309, but which in fact do not belong to clothes. Clutters are handled in two ways, depending on their predictability. Predictable clutters are removed by clothes recognition module 131 using clutter detectors. The influence of random clutters is diminished during the feature extraction method described in FIG. 7. Random clutters are images of objects or areas that are not persistent across pictures.

A prevalent type of predictable clutter is human skin, which can frequently occlude or mix with clothes areas in pictures. Clothes recognition module 131 builds a skin detector to detect human skin clutters in clothes (S311). The skin detector is built by learning characteristics of skin in the images from the set of images. To build the skin detector, clothes recognition module 131 uses techniques similar to the techniques described in FIG. 7 for clothes representation by feature extraction. Using the skin detector, clothes recognition module 131 detects and removes skin clutters (areas) from the identified clothes areas (S313). Clothes areas free of predictable clutters are obtained.

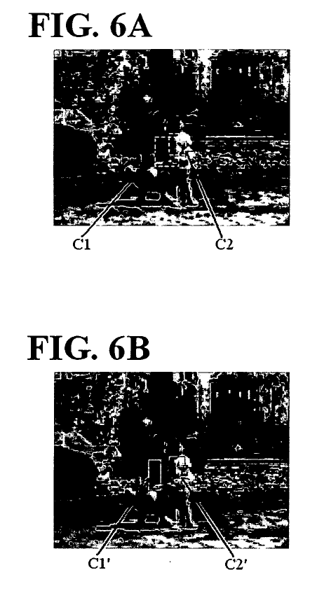

FIG. 6A illustrates an exemplary result of initial detection of clothes location according to an embodiment of the present invention illustrated in FIG. 5. FIG. 6A shows an initial estimation of clothes location from face detection, as described in step S305 in FIG. 5. The small circles on faces show the eye positions and identify two faces obtained from face detection in step S301 or S303 of FIG. 5. The locations of clothes C1 of one person and of clothes C2 of a second person are identified below the detected faces and are shown using dashed lines.

FIG. 6B illustrates an exemplary result of clothes segmentation to refine clothes location according to an embodiment of the present invention illustrated in FIG. 5. FIG. 6B shows refined locations of clothes C1′ and C2′ for the two persons from FIG. 6A, obtained through segmentation in step S309 of FIG. 5. The refined locations of clothes were obtained by maximizing difference between clothes of people using color histograms.

FIG. 7 is a flow diagram illustrating a technique for clothes representation by feature extraction according to an embodiment of the present invention illustrated in FIG. 4. FIG. 7 describes a technique for performing step S250 from FIG. 4. After extraction of clothes areas from images, quantitative representation of clothes is performed using feature extraction.

Scientific research literature typically describes two types of features that can be extracted from a set of data: local features and global features. Local features have received a lot of research attention and have been successfully used in some recognition systems. However, most local features are selected based on a type of local extrema, such as extrema of ‘maximum entropy’ or ‘maximum change’. Local extrema methods encounter challenges when clothes areas under consideration are smooth colored regions without textures or patterns, such as a single-colored T-shirt.

Global features methods using color histograms and/or orientation histograms may perform better for clothes representation. Color histogram methods, however, are not robust against lighting variations in pictures. Clothes are often folded and contain micro-folds that create false edges and self-shadows. Such false edges and shadows present challenges to orientation histogram methods. Since global representations are more robust that local representations against pose changes in images, global representations provide a good basis for a robust feature extraction method for clothes.

To take advantage of global representations, the features extracted for clothes representation are histograms. Unlike color histograms or orientation histograms however, the histograms for clothes representation are histograms of representative patches for the clothes under consideration. The representative patches for clothes also exclude random clutters. In order to extract representative patches for clothes, a feature extraction method is devised that automatically learns representative patches from a set of clothes. The feature extraction method uses the frequencies of representative patches in clothes as feature vectors. The feature extraction method therefore extracts feature vectors as sets of frequencies of code-words.

Code-words are first learned for the clothes in the set of images. Clothes pieces output from the clutter removal step S313 shown in FIG. 5 are normalized by clothes recognition module 131, according to the size of faces determined from face detection (S350). Overlapped small clothes image patches are taken from each normalized clothes piece (S352). In one implementation, small clothes image patches are selected as 7×7 pixel patches with two neighboring patches 3 pixels apart. All small clothes image patches from all the clothes pieces in the image set are gathered. Suppose N such small clothes image patches were obtained. Clothes recognition module 131 then creates N vectors that contain the color channels for the pixels in the small clothes image patches (S354). For an implementation using N number of 7×7 pixel small clothes image patches, each vector contains the color channels for the pixels in one 7×7 pixel small clothes image patch. Typically, each pixel has 3 color channels. Hence there are 3 color channels for each 7×7 pixel small clothes image patch, so the associated vector of that small image patch is 7×7×3=147-dimensional, and there are N such 147-dimensional vectors for all small clothes image patches.

In order to get rid of noise and make the computation efficient, principal component analysis (PCA) is used with the N vectors, to reduce the dimensionality of the data set of N vectors (S356). PCA also reduces the presence of random clutters and noise present in the clothes patches. Each small clothes image patch is represented by projections under the first K principal components, and N k-dimensional vectors are obtained (S358). In one implementation k=15 was used for 7×7 pixel small clothes image patches, so that each 7×7 pixel small clothes image patch is represented by projections under the first 15 principal components.

Vector quantization, such as K-means clustering, is then run on the N k-dimensional vectors to obtain code-words (S360). The Mahalanobis distance, given by d(x₁,x₂)=\sqrt{(x₁−x₂)^{T}Σ⁻¹(x₁−x₂)} for any two vectors x₁ and x₂ (where Σ is the covariance matrix), is used for K-means clustering. The code-words are the centers of clusters obtained through K-means clustering (S363). The number of code-words, which is the number of clusters for K-means clustering, can vary according to the complexity of the data. In one implementation, 30 code-words were used.

Each small clothes image patch is associated with a k-dimensional vector which belongs to one of the clusters. The code-word associated with that cluster is hence associated with that small clothes image patch. Therefore, by vector quantization, each small clothes image patch is quantized into one of the code-words associated with clusters. A clothes piece contains a multitude of small clothes image patches, and therefore a multitude of code-words associated with its small image patches. A clothes piece can then be represented by a vector that describes the frequency of appearance of the code-words associated with all the small clothes image patches that compose that clothes piece (S366). Suppose the number of code-words for a clothes piece is C. The code-word frequency vector V_{thiscloth} for that clothes piece is then C-dimensional and is expressed as:

V_{thiscloth}=[ν₁, . . . , νᵢ, . . . , ν_{c}], where each component νᵢ is found by

$${v}_{i} = \frac{{n}_{i}^{thiscloth}}{{n}^{thiscloth}} ,$$

with

nᵢ^{thiscloth} being the number of occurrences of code-word i in the clothes piece, and n^{thiscloth} the total number of small clothes image patches in the clothes piece. ν₁, ν₂, . . . , ν_{c} are the feature vectors that represent the clothes piece.

The above feature extraction method has a number of advantages for clothes recognition. One advantage is that the clustering process selects consistent features as representative patches (code-words) automatically and is more immune to background clutters which are not consistently present in the images from the set of images. This is because small image patches from non-persistent background image data are less likely to form a cluster. Hence, by representing clothes pieces using code-word frequency vectors, the influence of random clutters (i.e., not persistent across pictures) is diminished. Another advantage is that the feature extraction method uses color and texture information at the same time, and therefore can handle both smooth and highly textured clothes regions. Yet another advantage is that code-word frequencies count all the patches and do not rely on particular clothes features. Hence the code-word frequency representation for clothes is robust when the pose of the person wearing the clothes changes. Another advantage is that the feature extraction method is more robust to lighting changes that a method based on color histograms. Image patches corresponding to the same clothes part can have different appearances due to lighting changes. For example a green patch can have different brightness and saturation under different lighting conditions. Through PCA dimension reduction and using the Mahalanobis distances, images of the same clothes patch under different lighting conditions are more likely to belong to the same cluster as determined by the feature extraction method, than to belong to the same color bin as determined by a color histogram method.

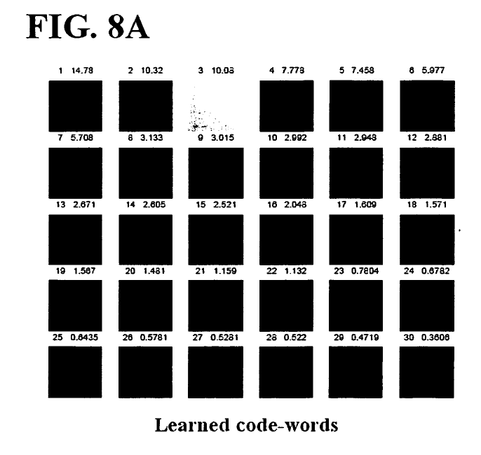

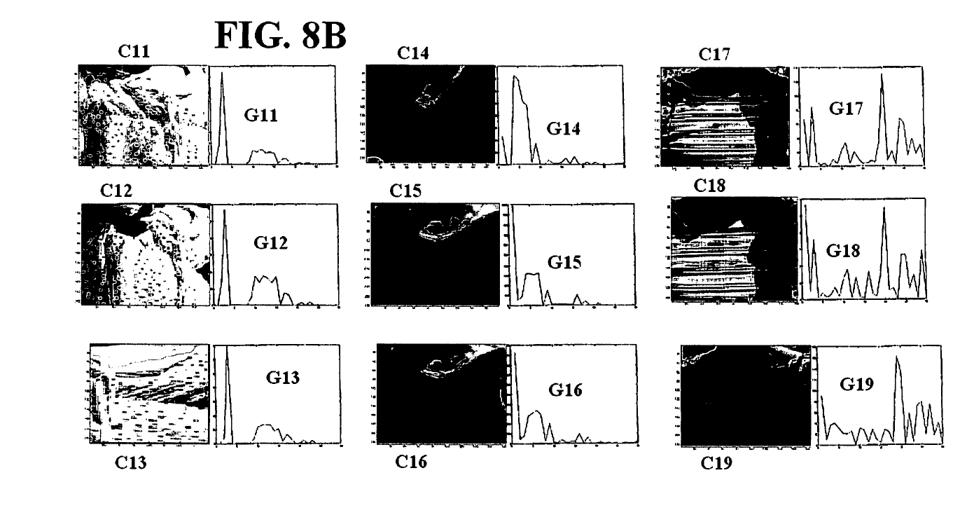

FIG. 8A illustrates exemplary code-words obtained from clothes feature extraction for clothes in a set of images according to an embodiment of the present invention illustrated in FIG. 7. FIG. 8A shows 30 code-words learned from the clothes areas including clothes areas C1′ and C2′ from FIG. 6B as well as other clothes areas, using PCA dimension reduction and vector quantization.

FIG. 8B illustrates exemplary code-words frequency feature vectors obtained for clothes representation of clothes in a set of images according to an embodiment of the present invention illustrated in FIG. 7. FIG. 8B shows code-word frequencies (which form the code-word frequency feature vectors) for 9 clothes areas C11, C12, C13, C14, C15, C16, C17, C18 and C19. The code-word frequencies graphs for the clothes areas are G11, G12, G13, G14, G15, G16, G17, G18 and G19. The code-word frequency graphs G11 to G19 are based on the code-words shown in FIG. 8A. As it can be seen in FIG. 8B, the clothes areas C11, C12 and C13 are similar, as they belong to the same article of clothing. The associated code-word frequencies graphs G11, G12, and G13 are also very similar to each other. Similarly, the clothes areas C14, C15 and C16 are similar, as they belong to the same article of clothing, and the associated code-word frequencies graphs G14, G15, and G16 are also very similar to each other. Finally, the clothes areas C17, C18 and C19 are similar as they belong to the same article of clothing, and the associated code-word frequencies graphs G17, G18, and G19 are also very similar to each other. Hence, clothes areas are well represented by code-word frequency feature vectors.

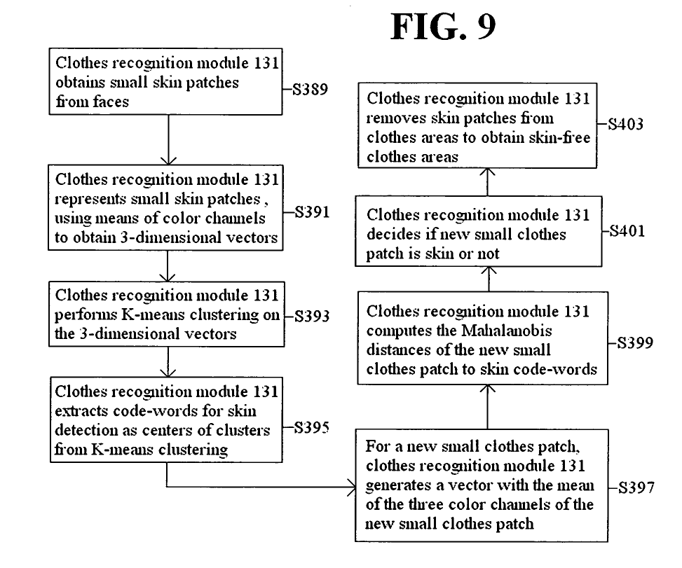

FIG. 9 is a flow diagram illustrating a technique for detection and removal of skin clutters from clothes in digital image data according to an embodiment of the present invention illustrated in FIG. 5. FIG. 9 describes a technique for performing steps S311 and S313 from FIG. 5. Skin is a common type of clutter that intermixes with clothes in images. General skin detection is not a trivial matter due to lighting changes in images. Fortunately, in a set of images, skin from faces and from limbs usually looks similar. Therefore a skin detector to detect skin from faces, limbs, etc, can be learned from faces.

The learning technique follows the code-word technique described for clothes in FIG. 7. Clothes recognition module 131 learns representative skin patches (code-words for skin detection) from faces. For this purpose, small skin patches are obtained from faces, mainly from the cheek part of the faces (S389). Each small skin patch is represented by the mean of each color channel from the 3 color channels of skin patch. K-means clustering is then performed on the 3-dimensional vectors (S393). The centers of clusters from K-means clustering form the code-words for skin detection (S395). Steps S389, S391, S393 and S395 show details of step S311 in FIG. 5.

Next, clothes recognition module 131 performs detection of skin in clothes. In order to decide whether a new small patch from a clothes area is skin or not, the vector with the mean of the three color channels is calculated for the new patch (S397). The Mahalanobis distances of the new patch to each of the skin code-words are computed (S399). If the smallest Mahalanobis distance obtained is less than a pre-defined threshold, and the new patch satisfies a smoothness criterion, the patch is taken as skin. The smoothness criterion measures smoothness of a new patch by the variance of luminance. Clothes recognition module 131 hence decides whether any patches from clothes areas are in fact skin (S401). Clothes recognition module 131 removes skin patches from clothes areas, so that only non-skin clothes patches are used for further analysis (S403).

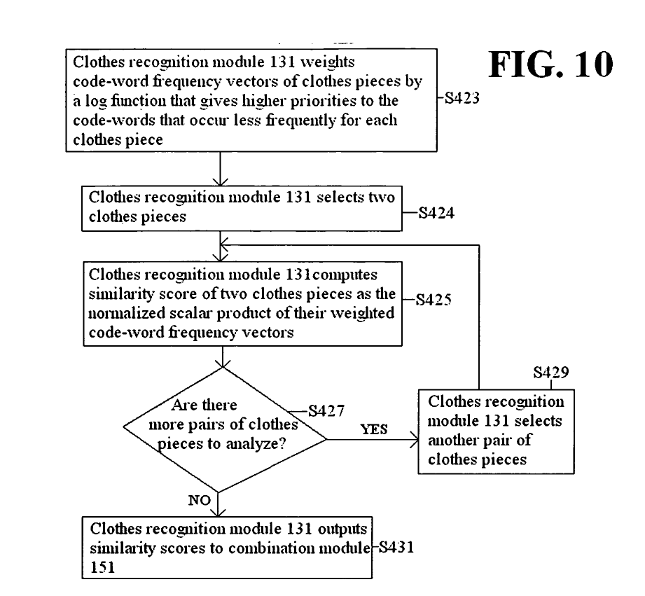

FIG. 10 is a flow diagram illustrating a technique for computing the similarity between pieces of clothes in digital image data according to an embodiment of the present invention illustrated in FIG. 4. FIG. 10 describes a technique for performing step S254 from FIG. 4. Clothes recognition module 131 may calculate the similarity between two pieces of clothes using methods similar to methods described in “Video Google: A Text Retrieval Approach to Object Matching in Videos”, by J. Sivic and A. Zisserman, in Proc. ICCV, 2003, which is herein incorporated by reference.

Each component of the code-word frequency vector of a clothes piece is multiplied by

$$log ( \frac{1}{{w}_{i}} ) ( S 423 ) ,$$

where wᵢ is the percentage of small patches of that clothes piece that are quantized into code-word i among all the N patches extracted in step S352 in FIG. 7. By multiplying the code-word frequency vector with these weights, higher priorities are given to the code-words that occur less frequently, since

$$log ( \frac{1}{{w}_{i}} )$$

is largest for the smallest percentage wᵢ. This similarity computation method is based on the idea that less frequent features in a clothes piece can be more distinctive, and therefore more important in characterizing a clothes piece.

Clothes recognition module 131 then selects two pieces of clothes (S424) and computes the similarity score of two pieces of clothes as the normalized scalar product of their weighted code-word frequency vectors (S425). The normalized scalar product is the cosine of the angle between two weighted code-word frequency vectors. Highly similar clothes pieces will have a similarity score close to 1, while highly dissimilar clothes piece with have a similarity score close to 0. Similarity scores are computed for all pairs of clothes pieces present in the images from the set of images (S427, S429). Clothes recognition module 131 then outputs the similarity scores of clothes pieces pairs to combination module 151 (S431).

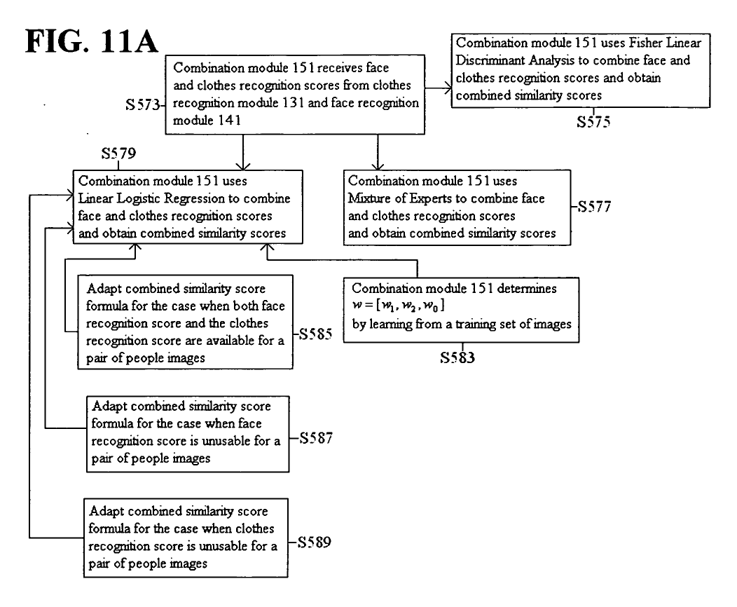

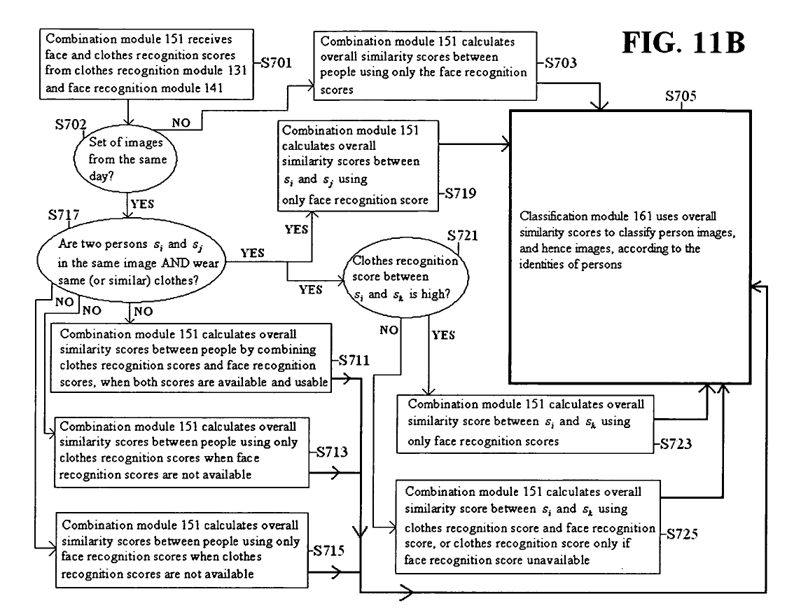

FIG. 11A is a diagram illustrating techniques for combining face and clothes recognition results to obtain combined similarity measures for person images according to an embodiment of the present invention. The techniques described in FIG. 11A can be used by combination module 151 to obtain combined similarity measures for person images during operation step S211 of FIG. 3. Linear logistic regression, Fisher linear discriminant analysis, or mixture of experts may be used to combine face and clothes recognition results and obtain combined similarity measures.

Clothes information is complimentary to faces information and is very useful when the face position and/or face angle changes, as is the case with profile faces, when the quality of the face image is poor, or when facial expression variations occur in images. More powerful results for identity recognition of people in images are achieved when face and clothes cues are integrated, than when face cues alone are used. Combination module 151 integrates clothes context with face context into similarity measures in the form of probability measures.

Mathematically, the cue combination problem can be described as follows. For any pair of images, let x₁ be the face recognition score from face recognition measuring similarity between faces of two persons that appear in images, and x₂ be the clothes recognition score from clothes recognition measuring similarity between clothes of the two persons. Let random variable Y indicate whether the pair of persons is the same person or not. Hence, Y=1 means that the two persons represent the same person, and Y=0 means otherwise. The problem of cue combination can be solved by finding a function ƒ(x₁,x₂) such that the probability
P(Y=1|x₁,x₂)=ƒ(x₁,x₂) (1)
is a good indicator of whether the pair of person images represent the same person or not.

In the linear logistic regression method, the function ƒ is of the form:

$$P ( Y = 1 \vert \overline{x} ) = f ( \overline{x} ) = \frac{1}{1 + exp ( - w \overline{x} )} \qquad ( 2 )$$

where e̅=[x₁,x₂,1]^{T}, and w=[w₁, w₂, w₀] is a 3-dimensional vector with parameters determined by learning from a training set of images (S583). The training set of images contains pairs of person images coming either from the same person or from different people. Face recognition scores and clothes recognition scores are extracted for the pairs of training images. The parameter w is determined as the parameter that can maximize the likelihood that the probability in equation (2) correctly describes if two people from training image pairs are the same person, and if two people from the training pairs are not the same person. Details on how w=[w₁, w₂, w₀] is determined from training images can be found in the cross-referenced related US application titled “Method and Apparatus for Adaptive Context-Aided Human Classification”, the entire contents of which are hereby incorporated by reference.

After the learning process, the parameter w is determined and used in linear logistic regression for actual operation of the image processing unit 31 to obtain combined similarity measures between people in new images, using face recognition and clothes recognition scores from new images (S579). For a pair of person images, the combined similarity measure P(Y=1) is obtained by introducing the face recognition scores and clothes recognition scores from the pair of person images into equation (2) (S585). P(Y=1) is the probability that the pair of persons actually represents the same person. The formula for calculating the probability P(Y=1) can be adapted accordingly for the case when either the face recognition score or the clothes recognition score is unusable or missing for a pair of person images (S587, S589). A detailed description of the linear logistic regression method and formula selection/adaptation method is found in the cross-referenced related US application titled “Method and Apparatus for Adaptive Context-Aided Human Classification”, the entire contents of which are hereby incorporated by reference.

Fisher linear discriminant analysis can also be used by combination module 151 to combine face and clothes recognition results and obtain combined similarity measures (S575). Fisher's discriminant analysis provides a criterion to find the coefficients that can best separate the positive examples (image pairs from the same person) and negative examples (pairs from different persons). The scores from face recognition and clothes recognition can be combined linearly using the linear coefficients learned via Fisher's linear discriminant analysis.

The mixture of experts is a third method that can be used by combination module 151 to combine face and clothes recognition results and obtain combined similarity measures (S577). The linear logistic regression method and the Fisher linear discriminant analysis method are essentially linear, and the combination coefficients are the same for the whole space. Mixture of experts provides a way to divide the whole space and combine similarity measures accordingly. The mixture of experts method is a combination of several experts, with each expert being a logistic regression unit. Combination module 151 may use the mixture of experts method described in “Hierarchical Mixtures of Experts and the EM Algorithm”, by M. I. Jordan and R. A. Jacobs, Neural Computation, 6: pp. 181-214, 1994, which is herein incorporated by reference.

FIG. 11B is a flow diagram illustrating a technique for determining similarity measures for person images based on availability of face and clothes similarity scores according to an embodiment of the present invention. The technique in FIG. 11B can be used by combination module 151 to determine similarity scores between people in images.

Suppose combination module 151 receives face and clothes recognition scores from clothes recognition module 131 and face recognition module 141 (S701). The face and clothes recognition scores are extracted for person images present in a set of images. Combination module 151 determines if the images from the set of images are from the same event (the same day) or not, by verifying the picture-taken-times of images or other implicit time or location information of images in the set of images (S702). Clothes provide an important cue for recognizing people in the same event (or on the same day) when clothes are not changed. If the images from the set of images are not from the same event and day, then combination module 151 calculates combined similarity measures, also called overall similarity scores herein, between people using only the face recognition scores (S703). Combination module 151 then sends the overall similarity scores to classification module 161.

If the images from the set of images are from the same day/event, then combination module 151 calculates overall similarity scores between people by combining both clothes recognition scores and face recognition scores, when both scores are available and usable (S711). If face recognition scores are not available for some pairs of person images, which could be the case when faces in images are profile faces or are occluded, combination module 151 calculates overall similarity scores between people using only clothes recognition scores (S713). If clothes recognition scores are not available for some pairs of person images, which could be the case when clothes are occluded in the images, combination module 151 calculates overall similarity scores between people using only face recognition scores (S715). Combination module 151 then sends the overall similarity scores to classification module 161.

A special case occurs when two people in an image wear the same (or similar) clothes. People wearing the same (or similar) clothes represents a difficult case for incorporating clothes information. Two persons in one picture usually are not the same individual. Therefore if in one picture, two persons sᵢ and sⱼ wear the same (or similar) clothes (S717), the clothes information needs to be discarded. Hence, when sᵢ and sⱼ from the same image have a high clothes similarity score, classification module 161 treats the clothes similarity score as missing, and uses only the face similarity score to compute the overall similarity score between sᵢ and sⱼ (S719).

Moreover, if the clothes similarity score between sᵢ and a third person sₖ (sₖ≠sⱼ) is high (S721), that is, the clothes of sₖ are very similar to the clothes of sᵢ (and hence, also to the clothes of sⱼ), then the clothes similarity score for sᵢ and sₖ is also treated as missing when calculating the overall similarity score (S723). In the same manner, if the clothes similarity score between sⱼ and a third person sₖ (sₖ≠sᵢ) is high, that is the clothes of sₖ are very similar to the clothes of sⱼ (and hence, also to the clothes of sᵢ), then the clothes similarity score for sⱼ and sₖis also treated as missing when calculating the overall similarity score.

However, if the pair-wise clothes similarity between sᵢ and another person image sₖ (sₖ≠sⱼ) located in any image from the set of images is not high, the clothes recognition score between sᵢ and sₖ can be used when calculating the overall similarity score, together with the face recognition score if available (S725). Similarly, if the pair-wise clothes similarity between sⱼ and another person image sₖ (sₖ≠sᵢ) located in any image from the set of images is not high, the clothes recognition score between sⱼ and sₖ can be used when calculating the overall similarity score, together with the face recognition score if available.

Classification module 161 receives all overall similarity scores and uses the scores to cluster images based on identities of persons in the images (S705).

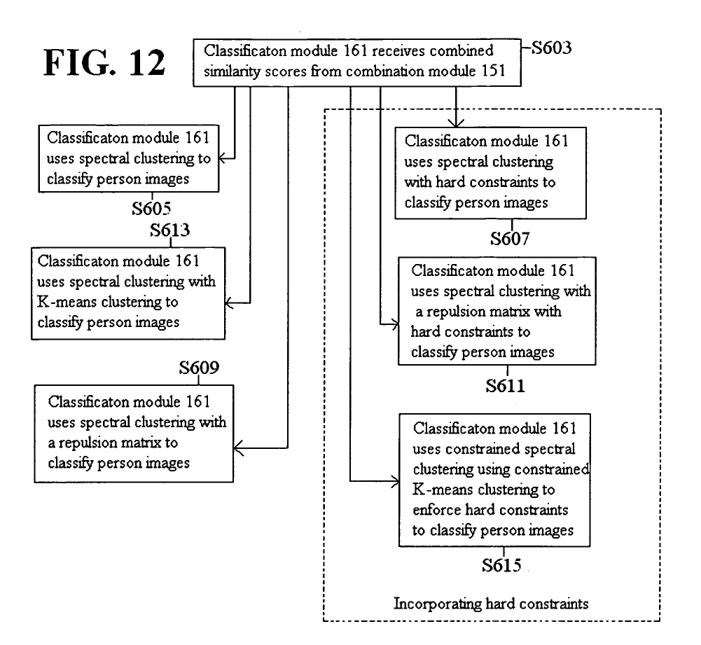

FIG. 12 is a flow diagram illustrating techniques for performing classification of person images based on person identities according to an embodiment of the present invention. The techniques described in FIG. 12 can be used by classification module 161 to classify images into groups according to the identities of the persons present in the images, in step S215 in FIG. 3. Methods that can be used to classify images into groups according to the identities of the persons present in the images include: spectral clustering; spectral clustering with hard constraints; spectral clustering using K-means clustering; spectral clustering using a repulsion matrix; spectral clustering using a repulsion matrix with hard constraints; constrained spectral clustering using constrained K-means clustering to enforce hard constraints. Detailed descriptions for the above mentioned clustering methods is found in the cross-referenced related US application titled “Method and Apparatus for Performing Constrained Spectral Clustering of Digital Image Data”, the entire contents of which are hereby incorporated by reference.

Pair-wise combined similarity measurements (overall similarity score) obtained by combination module 151 provide grounds for clustering of people from images based on their identity, and hence, for clustering images according to the identities of the people shown in them.

Many clustering algorithms have been developed, from traditional K-means methods to the recent spectral clustering methods as described in “Normalized cuts and image segmentation”, by J. Shi and J. Malik, in Proc. CVPR, pages 731-737, June 1997, “Segmentation using eigenvectors: a Unifying View”, by Y. Weiss, in Proc. ICCV, 1999, “On spectral clustering: Analysis and an algorithm”, by A. Y. Ng, M. I. Jordan, and Y. Weiss, in NIPS 14, 2002, and Computational Models of Perceptual Organization, by Stella X. Yu, Ph.D. Thesis, Carnegie Mellon University, 2003, CMU-RI-TR-03-14. One major advantage of spectral clustering methods over K-means methods is that K-means methods can easily fail when clusters do not correspond to convex regions. The same is the case for mixture of models using EM, which often assume that the density of each cluster is Gaussian. In human clustering, imaging conditions can change in various aspects, leading to cluster that do not necessarily form a convex region. Therefore a spectral clustering algorithm is favored for human clustering in the present application.

Spectral clustering methods cluster points by eigenvalues and eigenvectors of a matrix derived from the pair-wise similarities between points. Spectral clustering methods do not assume global structures, so these methods can handle non-convex clusters. Spectral clustering is similar to graph partitioning: each point is a node in the graph and similarity between two points gives the weight of the edge between those points. In human clustering, each point is a person's image, and similarity measurements are probabilities of same identity derived from face and/or clothes recognition scores.

One effective spectral clustering method used in computer vision is the method of normalized cuts, as described in “Normalized Cuts and Image Segmentation”, by J. Shi and J. Malik, in Proc. CVPR, pages 731-737, June 1997, which is herein incorporated by reference. The normalized cuts method from the above publication may be used by classification module 161 to perform spectral clustering classification in step S605. The normalized cuts method from the above publication is generalized in “Computational Models of Perceptual Organization”, by Stella X. Yu, Ph.D. Thesis, Carnegie Mellon University, 2003, CMU-RI-TR-03-14, which is herein incorporated by reference.

The normalized cuts criterion maximizes links (similarities) within each cluster and minimizes links between clusters. Suppose a set of points S={s₁, . . . , s_{N}} is to be clustered into K clusters. Let W be the N×N weight matrix, with term Wᵢⱼ being the similarity between points sᵢ and sⱼ. Let D denote the diagonal matrix with the i^{th} diagonal element being the sum of W's i^{th} row (i.e. the degree for the i^{th} node). The clustering results can be represented by a N×K partition matrix X, with Xᵢₖ=1 if and only if point sᵢ belongs to the k^{th} cluster, and 0 otherwise. Let Xₗ denote the l^{th} column vector of X, 1≦l≦K. Xₗ is the membership indicator vector for the l^{th} cluster. Using these notions, the normalized cut criterion finds the best partition matrix X* which can maximize

$$ɛ ( X ) = \frac{1}{K} {\sum }_{l = 1}^{K} \frac{{X}_{l}^{T} {WX}_{l}}{{X}_{l}^{T} {DX}_{l}} \qquad ( 3 )$$

Relaxing the binary partition matrix constraint on X and using Rayleigh-Ritz theorem, it can be shown that the optimal solution in the continuous domain is derived through the K largest eigenvectors of D^{-1/2}WD^{-1/2}. Let νᵢ be the i^{th} largest eigenvector of D^{-1/2}WD^{-1/2}, and V^{K}=[ν_{1, ν}₂, . . . , νₖ]. Then the continuous optimum of ε(X) can be achieved by X_{conti}*, the row normalized version of V^{K} (each row of X_{conti}* has unit length). In fact, the optimal solution is not unique—the optima are a set of matrices up to an orthonormal transformation: {X_{conti}*O:O^{T}O=I_{K}}where I_{K} is the K×K identity matrix.

Hence, for the operation of classification module 161 in steps S605 and S613 in FIG. 12, suppose a set of points S={s₁, . . . , s_{N}} is input into classification module 161, where each point sᵢ for 1≦i≦N is an image of a person (may include face or clothes or both) from the images from the set of images. Thus, if image I1 shows 3 people, image I1 contributes with s₁, s₂ and s₃ to the set S. If image I2 shows 2 people, image I2 contributes with s₄ and s₅ to the set S. And so on. The points s₁, s₂, . . . , s_{N} are to be clustered into K clusters, with each cluster corresponding to one identity among K identities of people found in the images. The similarity between two points can be computed from face recognition and/or clothes recognition results by combination module 151. From these similarity measurements, the N by N affinity matrix A is formed, with each term Aᵢⱼ being the similarity score between sᵢ and sⱼ for i≠j, and Aᵢᵢ=0 for the diagonal terms. Classification module 161 then defines D as the diagonal matrix whose i^{th} diagonal element is the sum of A's i^{th} row. Classification module 161 then constructs the matrix L=D^{-1/2}AD^{-1/2}, finds the K largest eigenvectors of L, and forms the matrix X by stacking these eigenvectors in columns. Classification module 161 then forms the matrix Y by re-normalizing each of X's rows to have unit length. Treating each row of Y as a point, classification module 161 clusters the rows of Y via K-means (S613) or other algorithms (S605). Finally, classification module 161 assigns each point sᵢ to cluster j if the i^{th} row of Y is assigned to cluster j.

The set of eigenvalues of a matrix is called its spectrum. The algorithm described for steps S605 and S613 makes use of the eigenvalues and eigenvectors of the data's affinity matrix, so it is a spectral clustering algorithm. The algorithm essentially transforms the data to a new space so that data are better clustered in the new space.

In the publication “Computational Models of Perceptual Organization”, by Stella X. Yu, Ph.D. Thesis, Carnegie Mellon University, 2003, CMU-RI-TR-03-14, which is herein incorporated by reference, a repulsion matrix is introduced to model the dissimilarities between points. Such a clustering algorithm may be used in step S609. The clustering goal becomes to maximize within-cluster similarities and between cluster dissimilarities, but to minimize their compliments. Suppose a set of points S={s₁, . . . , s_{N}} needs to be clustered into K clusters, where each point sₖ is an image of a person. Let A be the matrix quantifying similarities (affinity matrix), R be the matrix representing dissimilarities (repulsion matrix), and D_{A} and D_{R} be the diagonal matrices corresponding to the row sum of A and R respectively. Define
Ŵ=A−R+D_{R} (4)
and
\hat{D}=D_{A}+D_{R} (5).
The goal is then to find the partition matrix X that can maximize:

$$\frac{1}{K} {\sum }_{l = 1}^{K} \frac{{X}_{l}^{T} {WX}_{l}}{{X}_{l}^{T} {DX}_{l}} . \qquad ( 6 )$$

The continuous optima can be found through the K largest eigenvectors of \hat{D}^{-1/2}Ŵ\hat{D}^{-1/2} i a fashion similar to the case without a repulsion matrix.

Since a continuous solution can be found by solving eigensystems, the above method using an affinity matrix and a repulsion matrix is fast and can achieve a global optimum in the continuous domain. However, for clustering, a continuous solution needs to be discretized. In “Computational Models of Perceptual Organization”, by Stella X. Yu, Ph.D. Thesis, Carnegie Mellon University, 2003, CMU-RI-TR-03-14, discretization is done iteratively to find the binary partition matrix X_{discrete}* which can minimize ∥X_{discrete}−X_{conti}*O∥², where ∥M ∥ is the Frobenius norm of matrix M: ∥M∥=\sqrt{tr(MM^{T})}, O is any orthonormal matrix, and X_{conti}*O is a continuous optimum. The discretization performed to find the binary partition matrix X_{discete}*O completes step S609.

Classification module 161 may also cluster pictures according to each person's identity utilizing context information. Similarity computation between two points (two person images) is important in the clustering process. Besides faces and clothes in images, there may exist additional cues that can be incorporated and utilized to improve human recognition. Logic-based constraints represent additional cues that can help in clustering people in images based on identities. Logic-based context and constraints represent knowledge that can be obtained from common logics, such as the constraint that different faces in one picture belong to different individuals, or the constraint that husband and wife are more likely to be pictured together. Some logic-based constraints are hard constraints. For example, the constraint that different faces in one picture belong to different individuals is a negative hard constraint. Other logic-based constraints are soft constraints, such as the constraint that husband and wife are more likely to be pictured together. Another useful positive soft constraint is prior knowledge that a person is present in a group of images. Hence, the constraint that a face must belong to person A is a hard constraint. On the other hand, the constraint that the probability of a face belonging to person A is 0.8, is a soft constraint.

Hence, classification module 161 can improve human clustering results by using more context cues through incorporation into the clustering method of logic-based contexts that can be expressed as hard constraints. To make use of such hard constraints, the clustering approaches of steps S605, S609 and S613 are modified in steps S607, S611 and S615 by incorporating hard constraints.

It is desirable to be able to enforce such hard constraints in human clustering. However, incorporating priors (such as hard constraints) poses a challenge for spectral clustering algorithms. In “Computational Models of Perceptual Organization”, by Stella X. Yu, Ph.D. Thesis, Carnegie Mellon University, 2003, CMU-RI-TR-03-14, and “Grouping with Bias”, by S. X. Yu and J. Shi, in NIPS, 2001, a method to impose positive constraints (two points must belong to the same cluster) was proposed, but there is no guarantee that the positive constraints will be respected as the constraints may be violated in the discretization step. Classification module 161 may perform clustering of person images using an affinity matrix with positive constraints in step S607. Negative constraints may also be incorporated in an affinity matrix in step S607.

In step S611, classification module 161 implements a clustering approach using a repulsion matrix with hard constraints. Using the notations introduced for the clustering methods described by equations (4), (5) and (6), let S={s₁, . . . , s_{N}} be the set of points associated with person images from all the images from the set of images. The points s₁, s₂, . . . , s_{N} are to be to be clustered into K clusters, with each cluster corresponding to one identity among all K identities of people found in the images. The pair-wise similarity between two points sᵢ and sⱼ is obtained from face and/or clothes recognition scores and other context cues. The similarity values for pairs of person images were calculated by combination module 151 as probabilities for pairs of people to represent the same person. Using the similarity measurements associated with pairs of person images, classification module 161 forms an N by N affinity matrix A, with each term Aᵢⱼ being the probability similarity score between sᵢ and sⱼ for i≠j, and Aᵢⱼ=0 for i=j, that is Aᵢᵢ=0 for the diagonal terms of matrix A.

Suppose sᵢ and sⱼ are two person images that are found in the same picture. In this case, the two persons are typically different people (have different identities), so the classification module 161 should place sᵢ and sⱼ in different clusters. To embed this constraint, the term Aᵢⱼ in the affinity matrix A corresponding to the similarity between sᵢ and sⱼ is set to zero, Aᵢⱼ=0.

To enhance hard negative constraints, a repulsion matrix R is generated, to describe how dissimilar the two points sᵢ and sⱼ are. If sᵢ and sⱼ are two person images that are found in the same picture and therefore represent different people, the term Rᵢⱼ is set to be 1. More generally, the term Rᵢⱼ is set to be 1 if sᵢ and sⱼ cannot be in the same cluster. If there are no known constraints between two points sᵢ and sⱼ then the corresponding term Rᵢⱼ is set to be zero. Classification module 161 then performs spectral clustering with a repulsion matrix with hard constraints (S611). A detailed description of the clustering method using a repulsing matrix with hard constraints for step S611 is found in the cross-referenced related US application titled “Method and Apparatus for Performing Constrained Spectral Clustering of Digital Image Data”, the entire contents of which are hereby incorporated by reference.

Classification module 161 may also classify person images using constrained spectral clustering with constrained K-means clustering to enforce hard constraints to cluster images based on the identities of the people in the images (S615).

Although spectral clustering methods are more advantageous than K-means methods because K-means methods can easily fail when clusters do not correspond to convex regions, it is difficult to enforce hard constraints in spectral clustering methods. Introducing hard constraints in the affinity matrix A and in the repulsion matrix R may not be enough for enforcing these constraints, because there is no guarantee that the hard constraints are satisfied during the clustering step. Constrained K-means clustering is performed to ensure that the hard constraints are satisfied.

A constrained K-means algorithm that integrates hard constraints into K-means clustering is presented in “Constrained K-Means Clustering with Background Knowledge”, by K. Wagstaff, C. Cardie, S. Rogers, and S. Schroedl, in Proc. 18th International Conference on Machine Learning ICML, 2001, pp. 577-584, which is herein incorporated by reference. In the publication “On Spectral Clustering: Analysis and an Algorithm”, by A. Y. Ng, M. I. Jordan, and Y. Weiss, in NIPS 14, 2002, which is herein incorporated by reference, K-means was used in the discretization step. However, in this publication, a repulsion matrix was not used, the use of K-means with a repulsion matrix was not justified, the regular K-means instead of constrained K-means was used, and therefore no constraints were imposed.

In the current application, a constrained K-means algorithm is implemented in the discretization step to enforce hard constraints for human clustering in images. The constrained K-means algorithm may use methods described in publication “Contrained K-Means Clustering with Background Knowledge”, by K. Wagstaff, C. Cardie, S. Rogers, and S. Schroedl, in Proc. 18th International Conference on Machine Learning ICML, 2001, pp. 577-584, which is herein incorporated by reference.

Let S={s₁, . . . , s_{N}} be the set of points associated with person images from all the images from the set of images. The points s₁, s₂, . . . , s_{N}are to be to be clustered into K clusters, with each cluster corresponding to one identity among all K identities of people found in the images. As before, an affinity matrix A is generated, with each term Aᵢⱼ being the probability similarity score between sᵢ and sⱼ for i≠j, and Aᵢⱼ=0 for i=j, that is Aᵢⱼ=0 for the diagonal terms of matrix A. Classification module 161 also generates a repulsion matrix R to describe how dissimilar the two points sᵢ and sⱼ are.

Classification module 161 next embeds hard negative constraints in the affinity matrix A, by making Aᵢⱼ=0 when sᵢ and sⱼ are known to belong to different clusters (represent different people). Classification module 161 may embed hard positive constraints as well in the affinity matrix A, if positive constraints are available. An example of a positive constraint is the constraint that a person appears in consecutive pictures. For example, if it is known that two person images sᵢ and sⱼ in two images belong to the same individual, the algorithm can enforce such positive constraints by setting the term Aᵢⱼ=1 in the affinity matrix A, and the term Rᵢⱼ=0 in the repulsion matrix R. Such a hard positive constraint may be available from users' feedback, when an indication is received from a user of the application pinpointing a number of images in which a person appears. To embed hard negative constraints, the term Rᵢⱼ is set to be 1 if sᵢ and sⱼ cannot be in the same cluster (cannot represent different people). Classification module 161 may embed hard positive constraints as well in the repulsion matrix R, if positive constraints are available.

Classification module 161 then performs constrained spectral clustering using constrained K-means clustering to enforce hard constraints (S615). A detailed description of the constrained spectral clustering method using constrained K-means clustering to enforce hard constraints in step S615 is found in the cross-referenced related US application titled “Method and Apparatus for Performing Constrained Spectral Clustering of Digital Image Data”, the entire contents of which are hereby incorporated by reference.

The current application describes a method and an apparatus for context-aided human identification. The method and apparatus use face information, clothes information, and other available context information (such as the fact that people in one picture should be different individuals) to perform identification of people in images. The method and apparatus presented in the current application achieve a number of results. The method and apparatus presented in the current application implement a novel technique for clothes recognition by clothes representation using feature extraction. The method and apparatus presented in the current application develop a spectral clustering algorithm utilizing face, clothes, picture record data such as time (implicitly), and other context information, such as that persons from one picture should be in different clusters. The method and apparatus give results superior to traditional clustering algorithms. The method and apparatus presented in the current application are able to handle cases when face or clothes information is missing, by computing proper marginal probabilities. As a result, the method and apparatus are still effective on profile faces where only clothes recognition results are available, or when the clothes are occluded and face information is available. The method and apparatus in the current application are able to incorporate more context cues besides face and clothes information by using a repulsion matrix and the constrained K-means. For example, the method and apparatus are able to enforce hard negative constraints, such as the constraint that persons from one picture should be in different clusters. The method and apparatus in the current application are also able to handle cases when different people found in the same image wear the same (or similar) clothes.

Although the detailed embodiments described in the present application relate to human identification and face and clothes recognition or verification, principles of the present invention described may also be applied to different object types appearing in digital images.

Although detailed embodiments and implementations of the present invention have been described above, it should be apparent that various modifications are possible without departing from the spirit and scope of the present invention.

We claim:

1. A digital image processing method, said method comprising:
accessing digital data representing a plurality of digital images including a plurality of persons;
performing face recognition to generate face recognition scores relating to similarity between faces of said plurality of persons;
performing clothes recognition to generate clothes recognition scores relating to similarity between clothes of said plurality of persons;
obtaining inter-relational person scores relating to similarity between persons of said plurality of persons using said face recognition scores and said clothes recognition scores; and
clustering said plurality of persons from said plurality of digital images using said inter-relational person scores to obtain clusters relating to identities of said persons from said plurality of persons.

2. The digital image processing method as recited in claim 1, wherein said step of performing clothes recognition includes
segmenting clothes to obtain clothes areas in said plurality of digital images, and
removing clutters not belonging to said clothes areas.

3. The digital image processing method as recited in claim 2, wherein said step of performing clothes recognition includes
detecting clothes regions in said plurality of digital images by determining that sections in said plurality of digital images below faces of said plurality of persons are clothes regions associated with said faces,
wherein said sub-step of segmenting clothes determines clothes areas by maximizing a difference between said clothes regions.

4. The digital image processing method as recited in claim 2, wherein said sub-step of removing clutters includes removing data indicative of human skin.

5. The digital image processing method as recited in claim 2, wherein said step of performing clothes recognition includes
performing clothes feature extraction for said clothes areas obtained from said sub-step of removing clutters.

6. The digital image processing method as recited in claim 5, wherein said sub-step of performing clothes feature extraction includes
normalizing said clothes areas based on size of heads of said plurality of persons,
taking small image patches from said normalized clothes areas,
gathering said small image patches from said normalized clothes areas,
quantizing said small image patches using vector quantization to obtain patch vectors,
clustering said patch vectors to obtain patch clusters and code-words as centers of said patch clusters, and
representing said clothes areas by code-word feature vectors of frequencies of appearance of said code-words in said clothes areas.

7. The digital image processing method as recited in claim 6, wherein said step of performing clothes recognition includes computing clothes similarity by
weighting said code-word feature vectors such that higher priorities are given to code-words occurring less frequently, and
calculating said clothes recognition scores as a scalar product of said weighted code-word feature vectors for clothes areas pairs from said clothes areas belonging to different persons from said plurality of persons.

8. The digital image processing method as recited in claim 7, wherein said clothes of said plurality of persons include at least one of clothing, shoes, watch, and eyeglasses.

9. The digital image processing method as recited in claim 1, wherein said step of obtaining inter-relational person scores includes
applying a plurality of formulas for estimating probabilities for pairs of persons from said plurality of persons to represent the same person, based on availability of clothes recognition scores and face recognition scores for said pairs of persons.

10. The digital image processing method as recited in claim 9, wherein said step of obtaining inter-relational person scores
selects at least one formula from said plurality of formulas based on a time when images from said plurality of digital images were taken, to obtain an inter-relational person score between two persons from said plurality of persons,
selects at least one formula from said plurality of formulas based on a place where images from said plurality of digital images were taken, to obtain an inter-relational person score between two persons from said plurality of persons,
selects at least one formula from said plurality of formulas based on whether two persons A and B from said plurality of persons are wearing the same clothes in an image from said plurality of digital images, to obtain an inter-relational person score between said two persons A and B,
selects at least one formula from said plurality of formulas when only a face recognition score but no clothes recognition score is available for two persons C and D from said plurality of persons, to obtain an inter-relational person score between said two persons C and D,
selects at least one formula from said plurality of formulas when only a clothes recognition score but no face recognition score is available for two persons E and F from said plurality of persons, to obtain an inter-relational person score between said two persons E and F, and
selects at least one formula from said plurality of formulas when both a face recognition score and a clothes recognition score is available for two persons H and J from said plurality of persons, to obtain an inter-relational person score between said two persons H and J.

11. The digital image processing method as recited in claim 9, wherein said step obtaining inter-relational person scores further includes
obtaining said plurality of formulas using logistic regression, and
learning parameters for said plurality of formulas using logistic regression, before said sub-step of applying said plurality of formulas.

12. The digital image processing method as recited in claim 1, wherein said step of clustering includes
performing a spectral analysis to obtain eigenvector results from an arrangement of said inter-relational person scores, and
performing discretization of said eigenvector results by clustering said eigenvector results to obtain clusters relating to identities of said persons from said plurality of persons.

13. The digital image processing method as recited in claim 1, wherein said step of clustering includes
incorporating in an arrangement of said inter-relational person scores at least one hard constraint relating to persons from said plurality of persons, to obtain constrained inter-relational data results,
performing a spectral analysis to obtain eigenvector results from said constrained inter-relational data results, and
performing discretization of said eigenvector results by clustering said eigenvector results to obtain clusters relating to identities of persons from said plurality of persons.

14. The digital image processing method as recited in claim 1, wherein said step of clustering includes
incorporating in an arrangement of said inter-relational person scores at least one hard constraint relating to persons from said plurality of persons, to obtain constrained inter-relational data results,
performing a spectral analysis to obtain eigenvector results from said constrained inter-relational data results, and
performing discretization of said eigenvector results using constrained clustering with a criterion to enforce said at least one hard constraint to obtain clusters relating to identities of persons from said plurality of persons.

15. The digital image processing method as recited in claim 14, wherein said sub-step of performing discretization uses constrained K-means clustering.

16. The digital image processing method as recited in claim 15, wherein said at least one hard constraint includes a hard negative constraint that two persons found in the same image from said plurality of digital images have different identities.

17. The digital image processing method as recited in claim 15, wherein said at least one hard constraint includes a positive constraint based on predetermined knowledge that two persons found in different images from said plurality of digital images are the same person.

18. The digital image processing method as recited in claim 1, wherein
said step of obtaining inter-relational person scores includes obtaining an affinity matrix A using said face recognition scores and said clothes recognition scores; and
said step of clustering includes
incorporating in said affinity matrix A at least one hard negative constraint,
generating a repulsion matrix R using said at least one hard negative constraint,
using said affinity matrix A and said repulsion matrix R to obtain constrained inter-relational data results in the form of an inter-relational data matrix L;
selecting a predetermined number of largest eigenvectors of said inter-relational data matrix L,
stacking selected eigenvectors into columns to obtain a matrix X,
normalizing the rows of said matrix X to unit length to obtain said eigenvector results in the form of a matrix Y,
clustering rows of said matrix Y using K-means clustering to obtain said clusters, and
assigning said persons to clusters to which rows of said matrix Y associated with said persons are assigned.

19. The digital image processing method as recited in claim 1, wherein
said step of obtaining inter-relational person scores includes obtaining an affinity matrix A using said face recognition scores and said clothes recognition scores; and
said step of clustering includes
incorporating in said affinity matrix A at least one hard constraint,
using said affinity matrix A to obtain constrained inter-relational data results in the form of an inter-relational data matrix L;
selecting a predetermined number of largest eigenvectors of said inter-relational data matrix L,
stacking selected eigenvectors into columns to obtain a matrix X,
normalizing the rows of said matrix X to unit length to obtain said eigenvector results in the form of a matrix Y,
clustering rows of said matrix Y using constrained clustering using a criterion to enforce said at least one hard constraint to obtain said clusters, and
assigning said persons to clusters to which rows of said matrix Y associated with said persons are assigned.

20. The digital image processing method as recited in claim 1, wherein said clustering step assigns digital images of said plurality of digital images to clusters to which persons from said plurality of persons in said digital images are clustered.

21. A digital image processing apparatus, said apparatus comprising:
an image data unit for providing digital data representing a plurality of digital images including a plurality of persons;
a face recognition unit for generating face recognition scores relating to similarity between faces of said plurality of persons;
a clothes recognition unit for generating clothes recognition scores relating to similarity between clothes of said plurality of persons;
a combination unit for obtaining inter-relational person scores relating to similarity between persons of said plurality of persons using said face recognition scores and said clothes recognition scores; and
a classification unit for clustering said plurality of persons from said plurality of digital images using said inter-relational person scores to obtain clusters relating to identities of said persons from said plurality of persons.

22. The apparatus according to claim 21, wherein said clothes recognition unit segments clothes to obtain clothes areas in said plurality of digital images and removes clutters not belonging to said clothes areas.

23. The apparatus according to claim 22, wherein said clothes recognition unit
detects clothes regions in said plurality of digital images by determining that sections in said plurality of digital images below faces of said plurality of persons are clothes regions associated with said faces,
segments clothes to obtain clothes areas by maximizing a difference between said clothes regions.

24. The apparatus according to claim 22, wherein said clothes recognition unit removes clutters by removing data indicative of human skin.

25. The apparatus according to claim 22, wherein said clothes recognition unit
performs clothes feature extraction for said clothes areas obtained after clutters are removed.

26. The apparatus according to claim 25, wherein said clothes recognition unit performs clothes feature extraction by
normalizing said clothes areas based on size of heads of said plurality of persons,
taking small image patches from said normalized clothes areas,
gathering said small image patches from said normalized clothes areas,
quantizing said small image patches using vector quantization to obtain patch vectors,
clustering said patch vectors to obtain patch clusters and code-words as centers of said patch clusters, and
representing said clothes areas by code-word feature vectors of frequencies of appearance of said code-words in said clothes areas.

27. The apparatus according to claim 26, wherein said clothes recognition unit generates clothes recognition scores by
weighting said code-word feature vectors such that higher priorities are given to code-words occurring less frequently, and
calculating said clothes recognition scores as a scalar product of said weighted code-word feature vectors for clothes areas pairs from said clothes areas belonging to different persons from said plurality of persons.

28. The apparatus according to claim 27, wherein said clothes of said plurality of persons include at least one of clothing, shoes, watch, and eyeglasses.

29. The apparatus according to claim 21, wherein said combination unit obtains inter-relational person scores by
applying a plurality of formulas for estimating probabilities for pairs of persons from said plurality of persons to represent the same person, based on availability of clothes recognition scores and face recognition scores for said pairs of persons.

30. The apparatus according to claim 29, wherein said combination unit obtains inter-relational person scores by
selecting at least one formula from said plurality of formulas based on a time when images from said plurality of digital images were taken, to obtain an inter-relational person score between two persons from said plurality of persons,
selecting at least one formula from said plurality of formulas based on a place where images from said plurality of digital images were taken, to obtain an inter-relational person score between two persons from said plurality of persons,
selecting at least one formula from said plurality of formulas based on whether two persons A and B from said plurality of persons are wearing the same clothes in an image from said plurality of digital images, to obtain an inter-relational person score between said two persons A and B,
selecting at least one formula from said plurality of formulas when only a face recognition score but no clothes recognition score is available for two persons C and D from said plurality of persons, to obtain an inter-relational person score between said two persons C and D,
selecting at least one formula from said plurality of formulas when only a clothes recognition score but no face recognition score is available for two persons E and F from said plurality of persons, to obtain an inter-relational person score between said two persons E and F, and
selecting at least one formula from said plurality of formulas when both a face recognition score and a clothes recognition score is available for two persons H and J from said plurality of persons, to obtain an inter-relational person score between said two persons H and J.

31. The apparatus according to claim 29, wherein said combination unit obtains said plurality of formulas using logistic regression, and learns parameters for said plurality of formulas using logistic regression.

32. The apparatus according to claim 21, wherein said classification unit clusters said plurality of persons by
performing a spectral analysis to obtain eigenvector results from an arrangement of said inter-relational person scores, and
performing discretization of said eigenvector results by clustering said eigenvector results to obtain clusters relating to identities of said persons from said plurality of persons.

33. The apparatus according to claim 21, wherein said classification unit clusters said plurality of persons by
incorporating in an arrangement of said inter-relational person scores at least one hard constraint relating to persons from said plurality of persons, to obtain constrained inter-relational data results,
performing a spectral analysis to obtain eigenvector results from said constrained inter-relational data results, and
performing discretization of said eigenvector results by clustering said eigenvector results to obtain clusters relating to identities of persons from said plurality of persons.

34. The apparatus according to claim 21, wherein said classification unit clusters said plurality of persons by
incorporating in an arrangement of said inter-relational person scores at least one hard constraint relating to persons from said plurality of persons, to obtain constrained inter-relational data results,
performing a spectral analysis to obtain eigenvector results from said constrained inter-relational data results, and
performing discretization of said eigenvector results using constrained clustering with a criterion to enforce said at least one hard constraint to obtain clusters relating to identities of persons from said plurality of persons.

35. The apparatus according to claim 34, wherein said classification unit performs discretization uses constrained K-means clustering.

36. The apparatus according to claim 35, wherein said at least one hard constraint includes a hard negative constraint that two persons found in the same image from said plurality of digital images have different identities.

37. The apparatus according to claim 35, wherein said at least one hard constraint includes a positive constraint based on predetermined knowledge that two persons found in different images from said plurality of digital images are the same person.

38. The apparatus according to claim 21, wherein
said combination unit obtains inter-relational person scores by obtaining an affinity matrix A using said face recognition scores and said clothes recognition scores; and
said classification unit clusters said plurality of persons by
incorporating in said affinity matrix A at least one hard negative constraint,
generating a repulsion matrix R using said at least one hard negative constraint,
using said affinity matrix A and said repulsion matrix R to obtain constrained inter-relational data results in the form of an inter-relational data matrix L;
selecting a predetermined number of largest eigenvectors of said inter-relational data matrix L,
stacking selected eigenvectors into columns to obtain a matrix X,
normalizing the rows of said matrix X to unit length to obtain said eigenvector results in the form of a matrix Y,
clustering rows of said matrix Y using K-means clustering to obtain said clusters, and
assigning said persons to clusters to which rows of said matrix Y associated with said persons are assigned.

39. The apparatus according to claim 21, wherein
said combination unit obtains inter-relational person scores by obtaining an affinity matrix A using said face recognition scores and said clothes recognition scores; and
said classification unit clusters said plurality of persons by
incorporating in said affinity matrix A at least one hard constraint,
using said affinity matrix A to obtain constrained inter-relational data results in the form of an inter-relational data matrix L;
selecting a predetermined number of largest eigenvectors of said inter-relational data matrix L,
stacking selected eigenvectors into columns to obtain a matrix X,
normalizing the rows of said matrix X to unit length to obtain said eigenvector results in the form of a matrix Y,
clustering rows of said matrix Y using constrained clustering using a criterion to enforce said at least one hard constraint to obtain said clusters, and
assigning said persons to clusters to which rows of said matrix Y associated with said persons are assigned.

40. The apparatus according to claim 21, wherein said classification unit assigns digital images of said plurality of digital images to clusters to which persons from said plurality of persons in said digital images are clustered.
